(19) United States
(12) Patent Application Publication
(10) Pub. No.: US 2004/0249859 A1
(43) Pub. Date: Dec. 9, 2004

(54) System and method for fingerprint based media recognition

(75) Inventors: Sean Ward, Alexandria, VA (US); Isaac Richards, Willoughby, OH (US)

Correspondence Address: MILES & STOCKBRIDGE PC, 1751 PINNACLE DRIVE, SUITE 500, MCLEAN, VA, 22102-3833, US

(73) Assignee: Relatable, LLC, Alexandria, VA

(21) Appl. No.: 10/799,917

(22) Filed: Mar. 15, 2004

Related U.S. Application Data
(60) Provisional application No. 60/454,329, filed on Mar. 14, 2003.

(51) Int. Cl. G06F 17/00

(52) U.S. Cl. 707/104.1

(57) ABSTRACT

A system for media recognition includes a media storage device having first and second storage components for storing segment lengths and fingerprint identifiers and fingerprint and fingerprint identifiers, respectively. Fingerprint and segment length information is extracted from the media storage device to derive a media description packet comprising one or more fingerprints and segment length information. The fingerprint and segment length packet in the media description packet is resolved and associated metadata, if any, is returned. If a matching segment record is not found for the media description packet, additional segment fingerprints and user input of associated metadata are requested.

### RELATED APPLICATIONS

This application claims the benefit of the filing date of provisional application 60/454,329, filed Mar. 14, 2003, and titled “A System And Method For Fingerprint Based Media Recognition”.

### FIELD OF THE INVENTION

The present invention is related to a method for the recognition of media, such as CDs or DVDs. More specifically, it relates to the recognition of media using a combination of acoustic and bit based fingerprints, and segment length information.

### DESCRIPTION OF THE PRIOR ART

Generally, media identification has been based on either the recovery of specially formatted metadata fields within the media, such as CD-TEXT in CDs, or on identifying identical pressings of a mass produced piece of media, such as CD table-of-contents information. Examples of table-of-contents based systems include U.S. Pat. No. 6,061,680, used in the commercial CDDB system by Gracenote, and the Musicbrainz and FreeDB systems available from open source public systems.

To address the limitations of TOC based systems, fingerprint based systems are able to identify items on a track level basis without embedding information. Examples of acoustic fingerprinting systems include US2002161741, US20020133499, and US20020083060. These systems however are unable to leverage the fact that most media is still mass produced, which allows additional pieces of information to aid in the identification of said media. Finally, such systems are unable to recognize media with pure data segments, such as computer data CDs.

Finally, bit based solutions (www.bitzi.com) have attempted to address the issue of file or media identification. These rely upon the computation of a bit-based hash, such as an MD5sum, or a tigertree hash, which determines how identical two files or media segments are. However, such systems are unable to cope with user created content, such as burned CDs, or format shifted media.

### SUMMARY OF THE INVENTION

This system for media recognition comprises two major parts: the media analysis component, and the media recognition component. Table of contents information (consisting of a table indicating the number and length of segments contained on the media) and an acoustic or bit based fingerprint of the contents of one or more segments from the media is collected by the media analysis component. This information is then used by the media recognition component to identify the media, and in the case that no matching media record is found, acoustic or bit-based fingerprints can be extracted from the remaining segments to attempt partial recognition on a per segment basis.

It is therefore an object of this invention to allow the recognition of both commercially available and user created media, in situations where existing segment length analysis fails. It is also an object of this invention to allow the partial identification of new media, when it contains any segments that existed on existing, indexed media. Additionally, it is an object of this invention to provide a useful balance between accuracy and computation cost of recognition, which a system built purely on acoustic fingerprinting, fails to achieve in the context of strictly media recognition. Finally, it is an object of this invention to provide accurate identifications of media with low segment counts, which have a poor accuracy rate in a pure segment length analysis.

### BRIEF DESCRIPTION OF THE DRAWINGS

In the drawings:

FIG. 1 is a logic flow diagram, showing the overview process of fingerprint-based media recognition.

FIG. 2 is a block diagram, showing the components of the media recognition component.

FIG. 3 is a logic flow diagram, showing the process of recognizing a piece of media from the summary fingerprints and table of contents information.

### DETAILED DESCRIPTION OF THE INVENTION

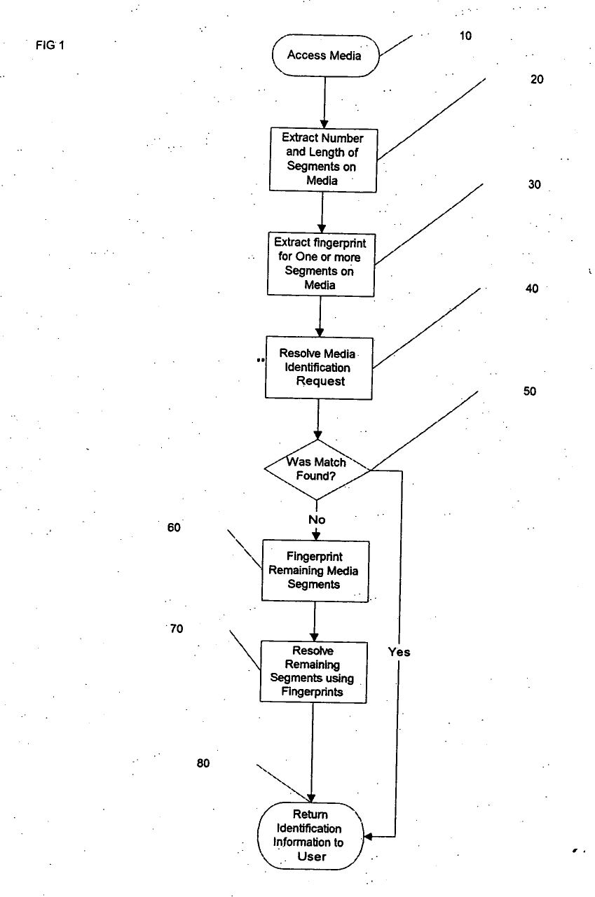

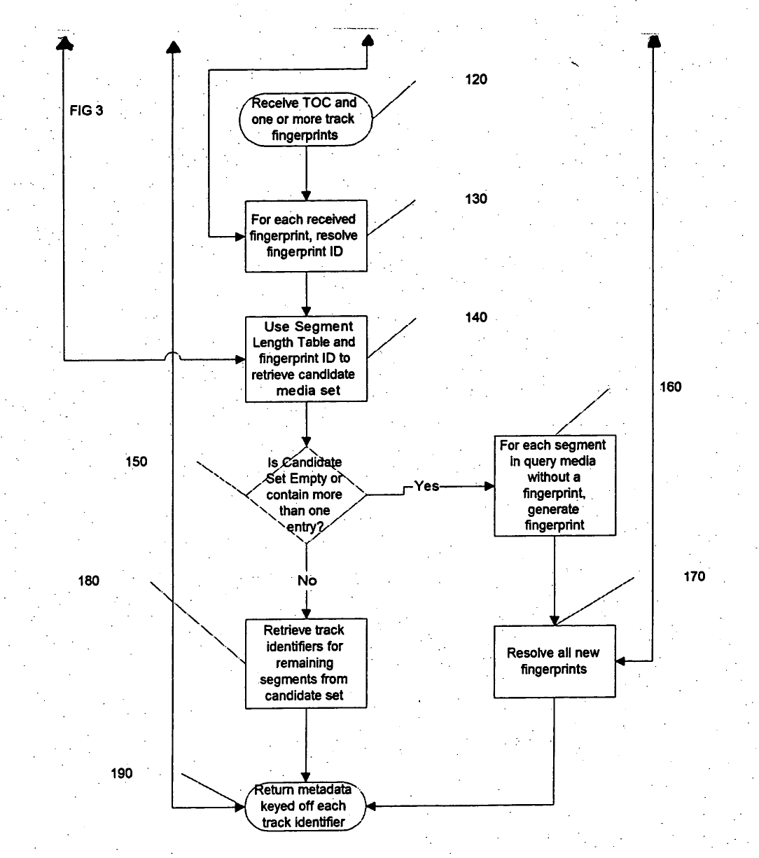

The ideal context of this system places the media analysis component within a media playback tool, such as a software media player or a hardware CD player. Referring to the flow diagram of FIG. 1, this system, upon a new piece of media, such as a CD or DVD, being inserted at access media step 10, proceeds to extract the table of contents segment information in step 20, and, depending on whether the segments within the media are data or audio, fingerprint one or more segments (step 30) to derive a media description packet. This media description packet is then transmitted to the media recognition component (step 40) for resolving the media identification request, the identification using the process illustrated in the flow diagram of FIG. 3.

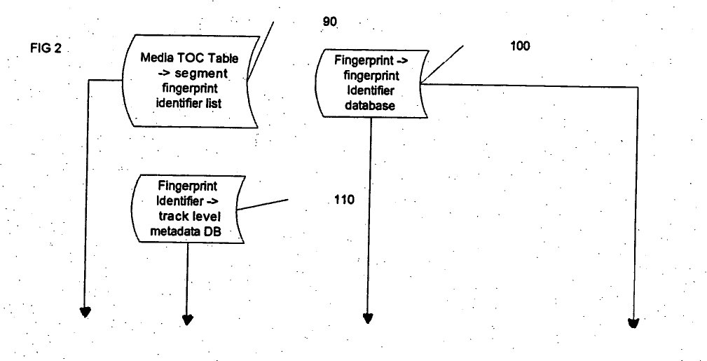

Ideally, the media recognition component (FIG. 2) is located on a remote server, using TCP/IP or http for communications. This allows a large-scale database to be centrally managed without replicating the database on each media identification client. However, in certain embedded applications, such as media player hardware units, which lack connectivity, the media recognition component may exist on the same device as the media analysis component.

The first step of recognition is the resolution of the fingerprints in the media description packet (step 120) wherein one or more track fingerprints are received. Depending on the type of fingerprint, this may require a query (step 130) against a reference acoustic fingerprint database (100), or reference bitprint database to resolve the fingerprint identification. In the context of a hash bitprint, the print may be the fingerprint identifier, such as with an MD5 sum. A query for table of content records containing the fingerprint identifiers and segment count in the incoming media description packet is then performed (step 140) using the TOC mapping database (90). Finally, that result set is culled based on the segment lengths matching those within the incoming media description packet.

In the event that the resulting media description record set contains more than one entry, or is empty, a response is sent back to the media analysis component requesting the fingerprints for all remaining media segments (step 60 and step 160). This allows the system to fall back to a segment level identification for user created media, such as burned CD's. Upon receiving the full set of fingerprints from the media analysis component (step 70), the recognition component resolves the fingerprint identifiers for each segment (step 170) using the fingerprint database (100). If all segments within the media matched known fingerprints, a new media description record can be automatically added to the system at this point as well.

In the event that the media description record set contains only one entry, then the fingerprint identifiers for all un-fingerprinted segments in the media can be retrieved from the description record, saving the cost of fingerprinting and resolving each segment individually (step 180).

The final step in the recognition process is the retrieval of the appropriate metadata for the media, using the segment level fingerprint identifiers and potentially a media identification identifier (step 190). This allows the returned metadata to account for duplicated segments on different media, such as returning the appropriate album for an audio track that appears on multiple CD's, and is stored in the identifier to metadata mapping database (110).

In the case where no fingerprint segments, or media description records match an incoming media description packet, a request can be sent back to the media analysis component that the user manually identify the work. This allows the system to index new media as it is encountered in actual usage. The manually identified media description record can then be sent from the media analysis component to the central media recognition component, where it can be stored for later addition to the system. Many insertion strategies are possible, including requiring a threshold of similar descriptions for a new media entry be collected before insertion occurs, or that human review is needed to allow the new entry to be added to the database.

While this invention has been described in conjunction with specific embodiments thereof, it is evident that many alternative modifications and variations will be apparent to those skilled in the art. Accordingly, the preferred embodiments of the invention as set forth herein are intended to be illustrative, not limiting. Various changes may be made without departing from the true spirit and scope of the invention as defined in the following claims.

1. A system for media recognition comprising:
A media storage device comprising:
a first storage component for segment lengths and fingerprint identifiers; and
a second storage component for fingerprint and fingerprint identifiers;
a first means configured to extract fingerprint and segment length information from the media storage device to derive a media description packet comprising one or more fingerprints and segment length information;
a second means configured to accept the media description packet, and
a third means configured to resolve the fingerprint and segment length packet, and return associated metadata, if any.

2. The media recognition system set forth in claim 1 further comprising a fourth means configured to request additional segment fingerprints if a matching segment record is not found for the media description packet.

3. The media recognition system set forth in claim 1 further comprising a fifth means configured to request user input of associated metadata if a matching segment record is not found for the media description packet.

4. The media recognition system set forth in claim 1 further comprising a third storage means for fingerprint identifier to metadata mappings, and a sixth means configured to translate segment level fingerprint identifiers to metadata using said metadata mapping.

5. A method for media recognition, comprising the steps of:
extracting one or more fingerprints and segment lengths from a media storage device to form a media description packet;
querying said media description packet against a resolution service, comprising the resolution of the one or more fingerprints in said media description packet, and the selection of one or more media description records containing matching fingerprint identifiers and segment lengths; and
returning the associated metadata from the reference media description record matching said media description packet.

6. The method for media recognition set forth in claim 5 wherein, if no media description record is found, additional fingerprints are extracted for each remaining segment from said media storage device, and a segment level identification is performed using said fingerprints.

7. The method for media recognition set forth in claim 6 comprising adding a new media description record if all segments within the record are properly resolved.

8. The method for media recognition set forth in claim 6 further comprising prompting to manually enter the metadata to complete a full media description record, and adding the completed record to the reference database.

9. The method for media recognition set forth in claim 7 further comprising prompting the user to manually enter the metadata for any unidentified segments, to complete a full media description record, and adding the completed record to the reference database.
